(19) United States
(12) Patent Application Publication
(10) Pub. No.: US 2026/0338218 A1
(43) Pub. Date: Oct. 29, 2026

(54) TACKING FASTENER ELEMENT AND METHOD OF INSTALLING SAME

(71) Applicant: Semblex Corporation, Elmhurst, IL (US)

(72) Inventors: Brandt J. Ruszkiewicz, Elmhurst, IL (US); Eric C. Breidenbaugh, Elmhurst, IL (US); Gene Simpson, Elmhurst, IL (US)

(21) Appl. No.: 19/189,937

(22) Filed: Apr. 25, 2025

(51) Int. Cl. F16B 25/10; F16B 25/00

(52) U.S. Cl. CPC F16B 25/106; F16B 25/0078

(57) ABSTRACT

A tacking fastener element including an elongated shaft, a tip portion configured to create sufficient heat, via friction during installation, to soften material of the workpiece adjacent the tip portion, thereby creating a flowed/extruded portion of the workpiece. The fastener element also includes a head portion that includes a drive region configured to receive a rotary driving force and an annular ring portion provided between the tip and head portions, wherein the annular ring portion includes a plurality of annular rings that are each non-helical and each include a crest, and wherein a root is defined between each pair of adjacent crests. A primary taper angle is defined between a pair of crest lines, wherein each of the crest lines is a line formed by connecting a radially outermost point of each of a plurality of the crests, and where the primary taper angle is between 10 and 20 degrees.

The present invention relates generally to tacking fastener elements, and more particularly to tacking fastener elements with a plurality of annular, non-helical, rings and a tip portion that is configured and arranged to generate heat during installation into a workpiece, thus allowing material of the workpiece to flow into root areas of the annular rings, thereby forming a strong bond.

### BACKGROUND OF THE INVENTION

Flow drill fasteners/screws, such as disclosed in U.S. Pat. No. 5,234,301, U.S. Pat. No. 8,348,572, and U.S. Pat. No. 9,175,708, are hole-forming, self-threading fasteners that utilize a terminating tip, opposite a head with a drive system, to generate heat and soften the base materials of the workpiece, thus allowing for the creation of a hole with minimal material removal. Following the hole-forming tip is a helical threaded region for forming threads into the formed hole prior to running down the fastener until the head of the fastener touches the workpiece and allows tightening of the joint to secure the layers of the workpiece together. Most flow drill fasteners have some type of undercut feature to encapsulate material of the workpiece that displaces towards the under-head region of the fastener during the hole forming process. As flow-drill fasteners are screws with helical threaded features, the tip of the screw must fully penetrate into the workpiece before the threads make contact. If this rule is violated, the helical angle of the threads will pull upwards on the formed thread in the base material, and if this jolt of force is not enough to pull the tip the rest of the way through the parts, the force will strip out the formed threads which reduces the joint strength and produces debris. As such, one weakness of flow drill screws relates to their size, as their hole forming tips and threaded regions must both be at least as thick the materials they are driven into. Once installed, the tip of the fastener, which generally terminates in a sharp point, will often protrude out of the workpiece, which may be unwanted in some applications, especially in automotive applications where that tip may face inwards towards occupants, presenting a significant safety risk in a crash event.

Another example of a flow-drilling fastener is disclosed in U.S. patent application Ser. No. 17/975,239 , filed on Oct. 27, 2022, which has been published as United States Patent Application Publication No. 2023/0129583, and which has been assigned to the Semblex Corporation of Elmhurst, Illinois, and which is hereby incorporated by reference herein.

Self-installing friction pin elements, similar to flow drill screws, may be installed using a combination of rotation and force (as disclosed in, for example, U.S. Pat. No. 10,508,676, US Patent Application Publication No. 2010/0186900, and U.S. Pat. No. 11,852,180, but such self-installing friction pin elements do not contain helical thread features, and as such are not considered to be screws. Relatively simple versions of friction pin elements are made in simple cone shapes (such as disclosed in US Patent Application Publication No. 2010/0186900), and are designed to create a hole in the workpiece using friction (like a flow drill screw), and then to allow the material to shrink back around the shaft of the pin as the material cools. There are no retaining features on this type of fastener, only a smooth surface cone. Other variants use constant diameter annular rings along a section of the body at varying angles to the fastener axis prior to the tip to allow the material to flow into while it cools after fastener installation (such as disclosed in U.S. Pat. No. 10,508,676).

Further developments on friction pins (such as disclosed in U.S. Pat. No. 11,852,180) combine threads and annular rings along of constant diameter with material removal sections designed to combine friction hole forming (as in flow drill screws) and more traditional hole forming operations that utilize cutting, such as milling/drilling.

Some friction pins utilize deformation of the fastener itself to form a pure friction weld between the lowest material in the target stack-up to be joined and the fastener itself (US Patent Application Publication No. 2013/0094896). Such methods require a backing plate to push the fastener against, and require the fastener and lowest material layer to be the same material to form a strong friction weld.

Other pin designs may be installed without rotation, and instead rely on short duration high force strikes like hammering nails (such as in U.S. Pat. No. 9,435,366). These fasteners utilize 90-degree flank angle sinusoidal curved rings of constant amplitude/diameter to capture material during the high-speed installation.

### BRIEF SUMMARY OF THE INVENTION

Briefly, the present relates to a joining element referred to as a tacking fastener. The tacking fastener element and installation method disclosed herein beneficially provides a short process time, low mass, joining method configured to join one or more components without sharp protrusions, and may be used with or without adhesive. The present tacking fastener element is comprised of a head with a built-in drive feature for transmitting rotation and load to the fastener. Adjacent to the head is a single or multi-section shaft comprised of tapered or cylindrical sections that may be wrapped in annular features. The annular features may be equally spaced. The ring shape may comprise symmetrical or non-symmetrical zones formed from straight and radiused sections. Terminating the shaft is a short concave tip used for generating heat allowing subsequent material flow into the ring features of the fastener, thereby forming a strong bond. Adjacent to the head opposite the terminating tip side may exist a second shaft that may or may not contain a helical or an annular feature for attaching additional components after the initial fastener installation utilizing the terminating point side of the fastener.

In particular, the present invention relates to a tacking fastener element that includes an elongated shaft extending in an axial direction between a first shaft end and a second shaft end; a tip portion provided at the first shaft end, wherein the tip portion is configured and arranged to create sufficient heat, via friction during installation into a workpiece, to soften material of the workpiece adjacent the tip portion, thereby creating a flowed/extruded portion of the workpiece. A head portion is arranged at the second shaft end, wherein the head portion includes a drive region configured and arranged to receive a rotary driving force. An annular ring portion is provided between the tip portion and the head portion, wherein the annular ring portion includes a plurality of annular rings that are each non-helical and each include a crest, and further wherein a root is defined between each pair of adjacent crests. A primary taper angle is defined between a pair of crest lines on radially opposite sides of each other, wherein each of the crest lines is a line formed by connecting a radially outermost point of each of a plurality of said crests, and preferably the primary taper angle is between approximately 10 degrees and approximately 20 degrees.

In certain embodiments of the invention, the crests comprise a plurality of first crests provided within a first region of the annular ring portion and a plurality of second crests provided within a second region of the annular ring portion, wherein the second region of the annular ring portion is closer to the head portion than the first region of the annular ring portion, and the pair of crest lines of the primary taper angle are associated with the plurality of first crests. Additionally, a secondary taper angle is defined between a pair of second crest lines on radially opposite sides of each other, wherein each of the second crest lines is a line formed by connecting a radially outermost point of each of a plurality of said second crests. In certain embodiments, the secondary taper angle is greater than the primary taper angle by approximately 15 degrees or less. Alternatively, the secondary taper angle may be less than the primary taper angle by approximately 15 degrees or less. Preferably, an under-head length, which is defined as an axial length between an underside surface of the head portion and a distal end surface of the tip portion, is greater than 3 times an outer diameter of the annular ring of largest diameter.

In certain embodiments of the present invention, at least some of the annular rings are arranged perpendicular to a central axis of the elongated shaft.

In certain embodiments of the present invention, all of the annular rings are arranged perpendicular to a central axis of the elongated shaft.

Preferably, the head portion includes an annular undercut region in an underside thereof, where the annular undercut region is configured and arranged for receiving material of the flowed/extruded portion of the workpiece created during installation of the tacking fastener element into the workpiece.

In certain embodiments, an axial length of the tip portion, as defined between a distal end surface of the tip portion and an adjacent one of the annular rings, is less than or equal to 0.8 times an outer diameter of the annular ring of largest diameter. Preferably, the axial length of the tip portion is also greater than or equal to 0.2 times the outer diameter of the annular ring of largest diameter.

In certain embodiments, an annular ring height, defined as a radial distance between a crest of an annular ring and an adjacent root, is the same for each of the plurality of annular rings of the annular ring portion. In other embodiments, the annular ring height differs between at least some of the plurality of annular rings of the annular ring portion.

In some embodiments, the annular ring height gradually increases between the annular ring closest to the tip portion and the annular ring closest to the head portion.

In certain embodiments, each of the annular rings is in the form of a triangle, when viewed in cross-section.

In some embodiments, each of the annular rings is in the form of sawtooth, when viewed in cross-section.

In certain embodiments, each of the annular rings includes an optimized smooth tapering sawtooth geometry which satisfies the following: (a) an advancing radius is 0.3-0.7 times the outer diameter of the annular ring of the largest diameter; (b) a root width is 0.13-0.25 times the outer diameter of the annular ring of the largest diameter; (c) a peak radius is 0.1-0.22 times the outer diameter of the annular ring of the largest diameter; (d) a retreating radius is 0.015-0.04 times the outer diameter of the annular ring of the largest diameter; (e) a retreating edge has an angle of 70-110 degrees relative to the central axis of the elongated shaft; and (f) an annular ring height is 0.075-0.15 times the outer diameter of the annular ring of the largest diameter.

In some embodiments of the present tacking fastener element, each of the annular rings includes an optimized bilinear geometry which satisfies the following: (a) a top angle φ is between 110 and 135 degrees; (b) a root angle a is between 35 and 60 degrees; (c) a top width is between 0.02 and 0.07 times the outer diameter of the annular ring of the largest diameter; (d) a root width is between 0.07 and 0.11 times the outer diameter of the annular ring of the largest diameter; (e) a root radius is approximately 0.02 times the outer diameter of the annular ring of the largest diameter; and (f) the annular ring height is between 0.04 and 0.08 times the outer diameter of the annular ring of the largest diameter.

The present invention also relates to an installation method for installing a tacking fastener element into a workpiece, using any of the embodiments of the tacking fastener element described herein, wherein the method includes rotating the tacking fastener element via the driver region at a speed ranging from between 2,000 RPM and 20,000 RPM while simultaneously applying a maximum of 5 kN end load axially to the tacking fastener element, thereby generating frictional heat at the first shaft end of the tacking fastener element resulting in material displacement upwards towards the head portion as the tip portion penetrates into the workpiece; and performing continued rotation such that the annular rings contact the workpiece, each subsequent ring displaces material of the workpiece using frictional softening from heat to fill a recess behind a preceding ring, thereby creating a wavelike effect of material deformation and flow as the tacking fastener element penetrates deeper into the workpiece.

In certain embodiments of the installation method, the head portion includes an annular undercut region in an underside thereof, where the annular undercut region is configured and arranged for receiving material of the flowed/extruded portion of the workpiece created during installation of the tacking fastener element into the workpiece, and the method further involves the annular undercut region compressing the material displaced upwards toward the head region behind a final one of the annular rings such that each space between adjacent annular rings is occupied with material of the workpiece; and terminating rotation of the tacking fastener element when the tacking fastener element has been driven to a target depth such that the underside of the head portion contacts a top surface of the workpiece. Additionally, the step of terminating rotation of the tacking fastener element could result in the underside of the head portion compressing into the top surface of the workpiece.

### BRIEF DESCRIPTION OF THE SEVERAL VIEWS OF THE DRAWINGS

Preferred embodiments of the present invention are described herein with reference to the drawings wherein:

FIG. 1 shows a cross-sectional view of a first embodiment of the present tacking fastener element;

FIG. 2 shows the present tacking fastener element of FIG. 1 with various critical dimensional relationships;

FIGS. 3A-3D show a side view of an example of the installation process of the tacking fastener element of FIG. 1;

FIG. 4 is a modified example of the tacking fastener element of FIG. 1 embodiment, including dual taper angles;

FIG. 5A shows an example of the present invention with a constant annular ring height;

FIG. 5B shows an example of the present invention with a variable annular ring height;

FIG. 6A shows an example of the present invention with optimized sawtooth annular ring geometry, and FIG. 6B shows a close-up of such optimized sawtooth geometry;

FIG. 7A shows an example of the present invention with optimized bi-linear annular ring geometry, and FIG. 7B shows a close-up of such optimized bi-linear geometry;

FIG. 8A shows an example of the present invention with simple triangular annular ring geometry;

FIG. 8B shows an example of the present invention with simple sawtooth annular ring geometry;

FIGS. 9A, 9B and 9C show examples of various tip configurations that may be used with the present invention; and

FIGS. 10A, 10B, 10C, 10D and 10E show examples of various head configurations that may be used with the present invention.

### DETAILED DESCRIPTION OF THE INVENTION

The invention disclosed herein relates to a fastening element that utilizes tapered annular rings, wherein the taper angle of the crests of the annular rings may or may not match the taper angle of the root or minimum point of the annular rings. The annular rings are optimized in size and taper angle to maximize the captured material of the workpiece softened during the installation operation. At the terminating end of the element (opposite the head) is a shaped tip designed to generate frictional heat to soften the target materials of the workpiece, and to then displace the material allowing the element to penetrate the material until the head of the element seats.

The element is designed to be spun at speeds ranging from 1,000 to 20,000 RPM while an axial force is applied to the element via a drive system that is incorporated into the head of the element. As the element is pushed against one or more target substrate materials, frictional heat is generated, softening the material, displacing and compressing it to make room for the tip as the element penetrates through the materials. As the element penetrates through the layers, each successive ring will force material into the recess area that precedes it closer to the tip of the element. Sharp edges are avoided in the annular ring design to prevent cutting and to encourage purely frictionally heated material flow to maintain high material strength after installation. Smooth transitions are used to control material flow, while steeper head facing flank angles are used to improve pullout resistance and joint strength. The taper angle of the rings and ring design is critical to ensuring that each progressive rings pushes material into trailing area before it. Without the tapering section of the element, material retention between the annular rings would be entirely based on material spring-back or retraction during cooling. However, this tapered array of annular ring features creates wave-like deformation through the material as each subsequent ring moves a wave of material into the preceding low spot between the rings.

As the tip displaces material prior to the rings making contact, some of that material will flow upwards towards the head of the element, termed up-flow. This up-flow of material will be contained using a specially designed annular undercut feature to fill in the area between the last annular ring crest and the undercut area of the element. The element is driven to depth whereas the bearing surface of the element is flush with the top surface of the upper substrate or slightly compressed into the top surface of the substrate. The installation process is a simple constant RPM, variable force install to a target depth after which the driver is turned off and retracted, leaving a completed joint.

The element may be manufactured from metals such as carbon steel, aluminum, or titanium or from polymers and composites, depending on the application and substrate materials the element will be installed into. The element may be plated with corrosion preventatives applied through conventional fastener plating processes such as dip spin or electroplating. The element may or may not have a torque modifying topcoat or sealer to encourage material flow, along with an optional sealant or adhesive applied to a portion or entirety of the tapered annular ring region based upon application specific requirements.

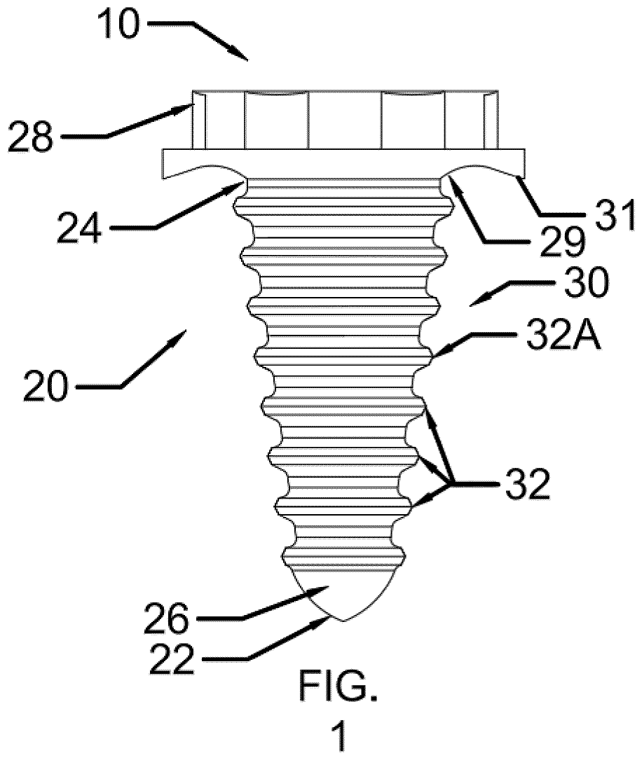

Turning now to the Figures, details of certain embodiments of the present invention are shown and will be described. FIG. 1 shows a cross-sectional view of a first embodiment of the present tacking fastener element 10. The tacking fastener element 10 of the present invention may be made of any suitable material, such as any of the following metals: (i) low and medium carbon steels; (ii) medium carbon alloy steels; (iii) stainless steels; (iv) high carbon steels; (v) high carbon alloy steels; and (vi) aluminum alloys. Additionally, it is also contemplated that the tacking fastener element 10 may also be made of non-metallic materials, such as polymers or high strength fiber filled composites, carbon nano-particle metallic composites, or metallic reinforced composite resins.

The tacking fastener element 10 includes an elongated shaft 20 that extends in an axial direction between a first shaft end 22 and a second shaft end 24. There is a tip portion 26 provided at the first shaft end 22, and a head portion 28 is arranged at the second shaft end 24. As discussed in more detail below, the head portion 28 includes a drive region that is configured and arranged to receive a rotary driving force for installing the tacking fastener element 10 into a workpiece.

The present tacking fastener element 10 also includes an annular ring portion 30 that is provided between the tip portion 26 and the head portion 28. The annular ring portion 30 includes a plurality of annular rings 32 (only some of which are numbered) that are each non-helical and each include a crest 32A. Further a root 32B is defined between each pair of adjacent crests 32A.

FIG. 1 also shows how in this embodiment, the head portion 28 includes an annular undercut region 29 in an underside surface 31 thereof, where the annular undercut region 29 is configured and arranged for receiving material of the flowed/extruded portion of the workpiece 10 created during installation of the tacking fastener element into the workpiece 10, as described more fully below. Although not shown, it is contemplated that the single undercut region 29 may be replaced by an undercut region that includes two, three or even more concentric undercut regions. Such multiple undercut regions may be of the same size as each other, or they may be of different sizes, such as becoming sequentially smaller in radial width (and/or more shallow) moving radially outwardly from one annular undercut region to the next.

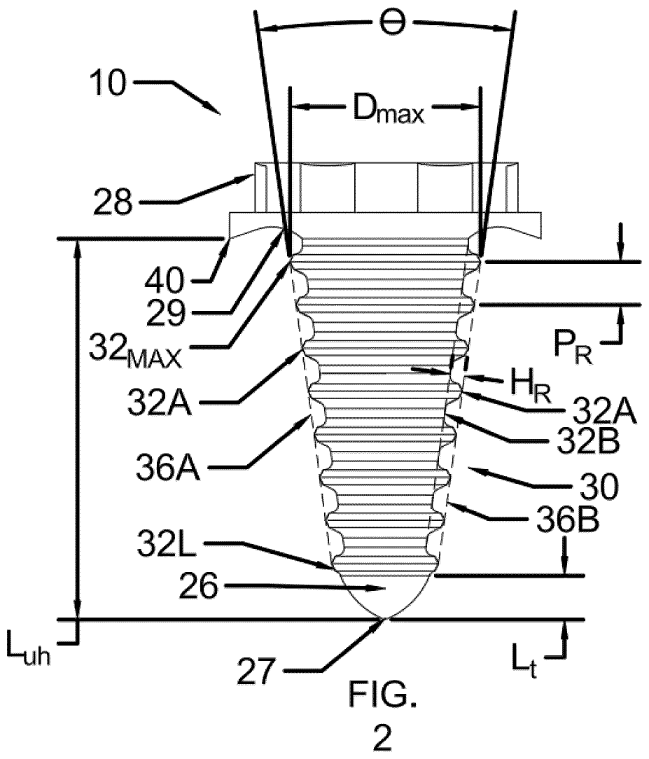

Turning now to FIG. 2, some of the important dimensions and dimensional relationships of the present tacking fastener element 10 will be described. As can be seen in FIG. 2, a primary taper angle θ is defined between a pair of crest lines 36/38 that are shown on radially opposite sides of each other. In particular, each of the crest lines 36/38 is a line formed by connecting a radially outermost point of each of the corresponding crests 32A that are adjacent to each other. Preferably, the primary taper angle θ is between approximately 10 degrees and approximately 20 degrees.

FIG. 2 also shows an axial tip length LT (also alternatively referred to herein as the “Tip Length”) of the tip portion 26, which is defined as the distance between a distal end surface 27 of the tip portion 26 and an adjacent one of the annular rings 32L (i.e., the lowermost of the annular rings). Further, FIG. 2 also shows the dimension DMAX, which is defined as outer diameter of the annular ring 32MAX of the largest diameter. Preferably, the axial tip length LT is less than or equal to 0.8 times an outer diameter DMAX of the annular ring 32MAX of largest diameter, while also being greater than or equal to 0.2 times the outer diameter DMAX of the annular ring 32MAX of largest diameter.

Towards the left of FIG. 2 is shown an under-head length LUH, which is the axial length between an underside surface 40 of the head portion 28 and a distal end surface 27 of the tip portion 26 (i.e., under-head length LUH is the axial length of the annular ring portion 30 plus the axial length of the tip portion 26). Preferably, the under-head length LUH is greater than 1.5 times the outer diameter (DMAX) of the annular ring DMAX of largest diameter.

Towards the right of FIG. 2 is shown the ring pitch PR, which is the spacing, in the axial direction, between two adjacent rings 30. Preferably, the ring pitch PR is the same between all of the rings. However, it is contemplated that the ring pitch could be different between at least some of the rings. For example, there could be a greater ring pitch between a group of rings close to the tip portion 26 than for those rings closer to the head portion 28, or the ring pitch could gradually decrease going from the rings close to the tip portion 26 to those close to the head portion 28. Additionally, FIG. 2 also shows how the ring height, HR, of a ring is defined as the radial distance between the root 32B of the ring and the crest 32A of the ring. In certain embodiments, the ring heights, HR are the same for all of the annular rings 32 within the annular ring portion 30, such as shown in FIG. 2, while in other embodiments at least some of the rings have different ring heights. For example, the annular rings 32 of the annular ring portion 30 can be divided into different groups, where the annular rings of each group have a different ring height, or the annular rings can be formed so that the annular ring height gradually increases between the annular ring closest to the tip portion and the annular ring closest to the head portion.

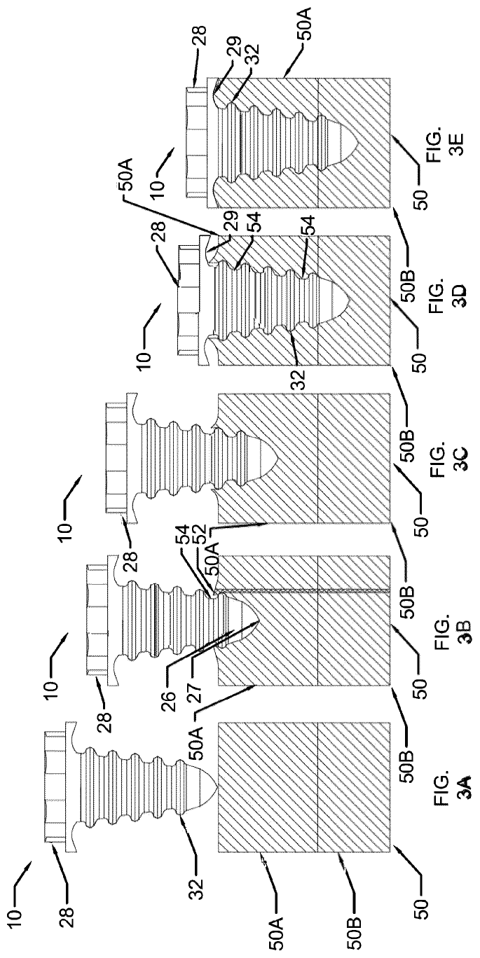

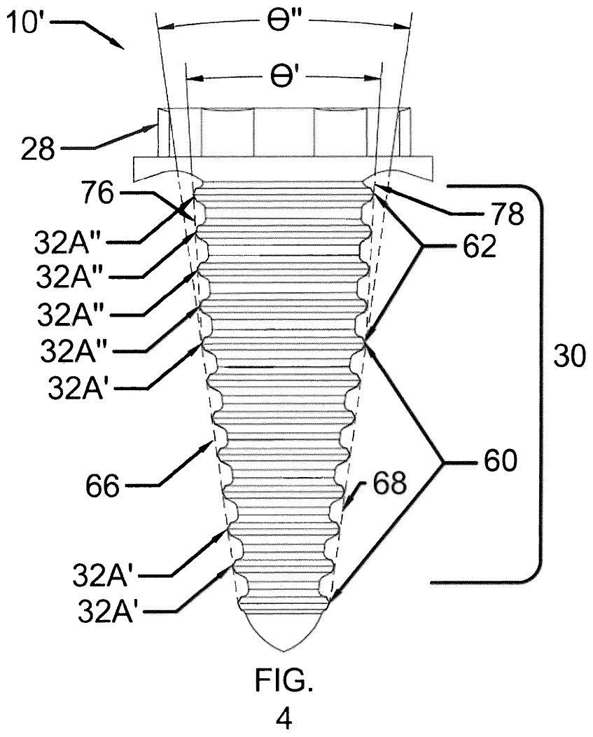

Turning now to FIGS. 3A-3E , the installation process will be explained. FIG. 3A shows how the tacking fastener element 10 has not yet been driven into a workpiece 50, which in this example consists of a first layer 50A and a second layer 50B, superposed on each other. The first and second layers 50A and 50B may each be of any suitable material (such as a sheet of aluminum, magnesium, steel, or other metal, plastic, carbon fiber reinforced plastic, carbon fiber, etc.,) where the first and second workpieces are of the same material or of different materials. Further, each of the workpieces may be of any suitable thickness, such as between 0.3 mm and 10.0 mm, or more. Optionally, an adhesive or sealer may be provided between the first and second workpieces prior to inserting the tacking fastener element therein.

When installing the fastener element 10, no hole in either of the mating layers 50A/50B is required, but a hole in either, or both, of the mating layers 50A/50B may be provided, if desired. If such a hole is provided, it is preferable of a diameter smaller than the smallest diameter of the of the roots of the annular rings. At the start of the installation proves, the fastener element 10 is spun and pushed against the upper surface of the first layer 50A.

FIG. 3B shows how rotation and downward axial movement of the fastener element 10 causes the distal end surface 27 of the tip portion 26 to penetrate into the material of the first layer 50A, thereby displacing and compressing this material of the first layer 50A, and this figures also shows how at least some of the material begins to flow upwards towards the direction of the head portion 28. The material near area 52 is sufficiently softened such that it flows into the trailing recess area 54 of the lowermost one of the annular rings 32. Any excess material will be compressed or displaced downwards.

FIG. 3C shows how as the tacking fastener element 10 continues to penetrate into the first layer 50A based on the continued rotation and axial movement, the material displaced from a ring just above the lowermost one of the rings 32 has now filled into the trailing recess 54 of the lowermost one of the rings 32, and more material moves upwards towards the head portion 28. It should be noted that, without a proper taper angle, as described later, such movement of the material into the trailing recess 54 will not occur.

Next, FIG. 3D shows how, with continued rotation and axial movement, all of the rings 32 have now penetrated into both layers 50A/50B of the workpiece 50, and the material displaced by each ring 32 has filled the trailing recess 54 of the preceding ring. The upward flow of material from the workpiece 50 has reached a maximum, but such material not yet made contact with the undercut region 29 of the head portion 28.

Finally, FIG. 3E shows how during the final stages of the installation, with continued rotation and axial movement of the fastener 10, the undercut region 29 recompresses the upflown material of the workpiece back into the space adjacent to the uppermost annular ring 32 and into the undercut region 32. Once the state of FIG. 3E has been reached, the rotation and axial movement of the fastener 10 is stopped.

Turning now to FIG. 4, a modified example of the tacking fastener element of FIG. 1 embodiment, where the version in FIG. 4 includes dual taper angles, a first, or primary, taper angle θ′ and a second, or secondary, taper angle θ″. In particular, FIG. 4 shows a tacking fastener element 10′ that includes a first (primary) taper angle θ′ and a second (secondary) taper angle θ″. As can be seen in this figure, there are a plurality of first crests 32A′ that are provided within a first region 60 of the annular ring portion 30 and a plurality of second crests 32A″ that are provided within a second region 62 of the annular ring portion 30. Further, FIG. 4 shows how the second region 62 of the annular ring portion 30 is closer to the head portion 28 than the first region 60 of the annular ring portion 30.

The primary taper angle θ′ is defined between a pair of first crest lines 66/68 that are shown on radially opposite sides of each other, and where the pair of first crest lines 66/68 is associated with the plurality of first crests 32A′. In particular, each of the first crest lines 66/68 is a line formed by connecting a radially outermost point of each of the corresponding first crests 32A′ that are adjacent to each other. Preferably, the primary taper angle θ is between approximately 10 degrees and approximately 20 degrees.

FIG. 4 also shows how the secondary taper angle θ″ is defined between a pair of second crest lines 76/78 on radially opposite sides of each other, and where each of the second crest lines 76/78 is a line formed by connecting a radially outermost point of each of a plurality of the second crests 32A″. In preferred embodiments, the secondary taper angle θ″ is either greater than the primary taper angle θ′ by approximately 15 degrees or less, or the secondary taper angle θ″ is less than the primary taper angle θ″ by approximately 15 degrees or less.

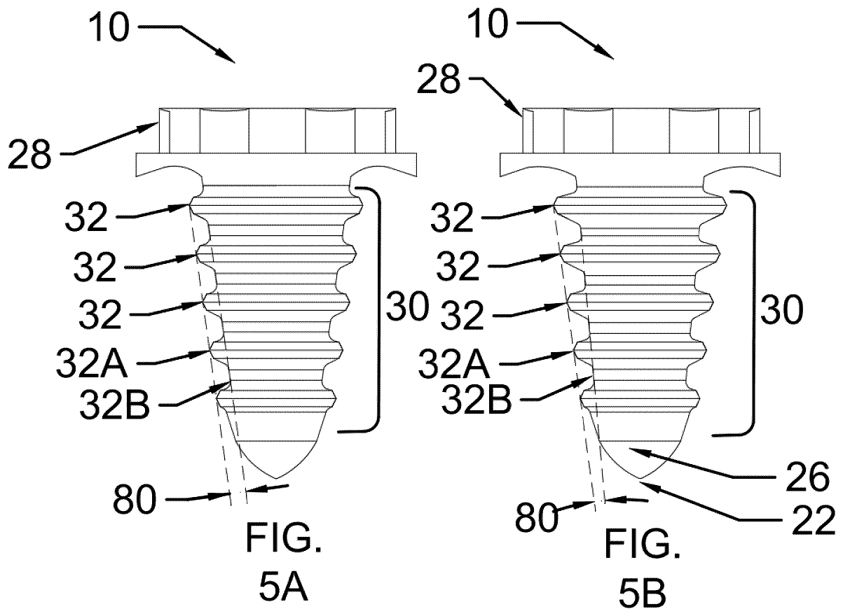

Turning now to FIGS. 5A and 5B, the annular ring height will be discussed. FIG. 5A shows an embodiment of the present tacking fastener element 10 in which the annular ring height 80, which is defined as a radial distance between a crest 32A of an annular ring 32 and an adjacent root 32B, is the same for each of the plurality of annular rings 32 of the annular ring portion 30. In particular, FIG. 5A shows how the radial distance 80 is defined between the two adjacent dashed lines, where one of the dashed lines goes through the outermost points of all of the crests 32A and the other dashed line goes through the base points of all of the roots 32B. In the FIG. 5A embodiment the annular ring heights 80 of all of the annular rings 32 are the same, and thus the two dashed lines are parallel to each other.

FIG. 5B shows an embodiment of the present tacking fastener element 10 in which the annular ring height 80, which is defined as a radial distance between a crest 32A of an annular ring 32 and an adjacent root 32B, is not the same for each of the plurality of annular rings 32 of the annular ring portion 30. In particular, FIG. 5B shows how the radial distance 80 is defined between the two adjacent dashed lines, where one of the dashed lines goes through the outermost points of all of the crests 32A and the other dashed line goes through the base points of all of the roots 32B. In the FIG. 5B embodiment the annular ring heights 80 differ between the annular rings 32, and thus the two dashed lines are not parallel to each other. In the FIG. 5B embodiment, the annular ring heights 80 get gradually larger going from the first shaft end 22 of the tip portion 26 towards the head portion. However, it is contemplated that other ways of varying the annular ring heights among the rings 32 of the annular ring portion 30 could be utilized. For example, the rings 3 of the annular ring portion 30 could be divided into two or more groups, with each group of rings having a different ring height, while rings within the same group have the same ring height, or in another embodiment, the lowermost one or two rings (near the tip portion) could have a first ring height, with the remainder of the rings having a second ring height that is the same for all of those rings, but that is different from the first ring height. Preferably, in embodiments in which the ring height varies, rings near the tip portion will have a smaller ring height than those near the head portion.

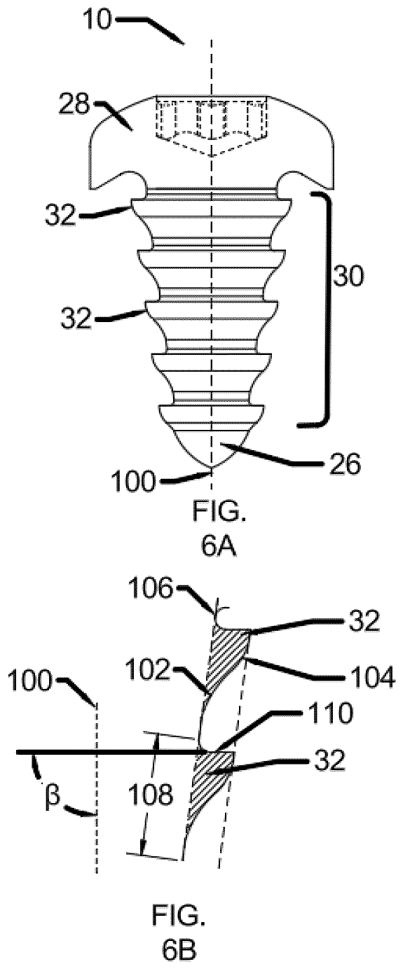

Turning now to FIGS. 6A and 6B, an example of an optimized smooth tapering sawtooth geometry of the annular rings is shown and will be described, wherein FIG. 6A shows a side view of a tacking fastener element 10, and FIG. 6B shows a close-up of the optimized sawtooth geometry.

As can be seen in the close-up view of FIG. 6B, the annular rings 32 of this embodiment each include an advancing radius 102, a peak radius 104, and a retreating radius 106. Further, the root width 108 is defined as the distance between the outer upper distal point of the retreating radius of the current annular ring and the outer upper distal point of the retreating radius of the adjacent ring that is directly below the current ring. FIG. 6B also shows a retreating edge angle β, which is the angle defined between the central axis 100 of the shaft and an extension of a line that coincides with the retreating edge 110.

In preferred embodiments of the present invention that include the optimized smooth tapering sawtooth geometry of FIGS. 6A and 6B, the following parameters are preferably satisfied: (a) the advancing radius 102 is 0.3-0.7 times the maximum annular ring diameter DMAX (FIG. 2); (b) the root width 108 is 0.13-0.25 times the maximum annular ring diameter DMAX (FIG. 2); (c) the peak radius 104 is 0.1-0.22 times the maximum annular ring diameter DMAX (FIG. 2); (d) the retreating radius 106 is 0.015-0.04 times the maximum annular ring diameter DMAX (FIG. 2); (e) the retreating edge 110 has an angle of 70-110 degrees relative to the central fastener axis 100; and (f) the annular ring height HR (FIG. 2) is 0.075-0.15 times the maximum annular ring diameter DMAX (FIG. 2).

Turning now to FIGS. 7A and 7B, an example of an optimized bilinear geometry of the annular rings is shown and will be described, wherein FIG. 7A shows a cross-sectional view of a tacking fastener element 10, and FIG. 7B shows a close-up of the optimized bilinear geometry.

As can be seen in the close-up view of FIG. 7B, the annular rings 32 of this embodiment each include a top angle o; a root angle a; a top width 112, which is measured via an imaginary line 113 that is parallel to the central axis 100, where the imaginary line 113 represents the radially outer width of a ring 32 at an area radially inward of where the ring starts to taper to its crest 32A; a root width 114; a root radius 116; and an annular ring height HR (FIG. 2).

In preferred embodiments of the present invention that include the optimized bilinear geometry of FIGS. 7A and 7B, the following parameters are preferably satisfied: (a) the top angle φ is between 110 and 135 degrees; (b) the root angle α is between 35 and 60 degrees; (c) the top width 112 is between 0.02 and 0.07 times the maximum annular ring diameter DMAX (FIG. 2); (d) the root width 114 is between 0.07 and 0.11 times the maximum annular ring diameter DMAX (FIG. 2); (e) the root radius 116 is approximately 0.02 times the maximum annular ring diameter DMAX (FIG. 2); and (f) the annular ring height HR (FIG. 2) is between 0.04 and 0.08 times the maximum annular ring diameter DMAX (FIG. 2).

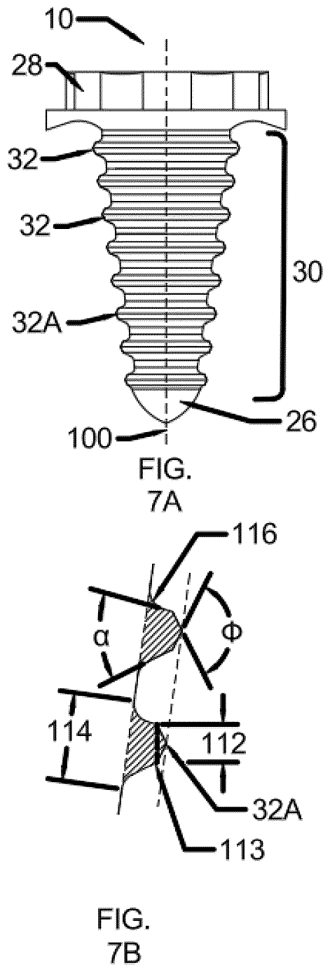

FIGS. 8A and 8B show two examples of different cross-sectional shapes for the annular rings of the present tacking fastener element. In particular, FIG. 8A shows a tacking fastener element 10 with a plurality of annular rings 132 that are each of a triangular shape, when viewed in cross-section, where each of the triangular rings 132 includes a crest 132A as its radially outermost point. Preferably, the triangular shape of each of the annular rings 132 is in the form of an isosceles triangle (where the two radially outer sides are of equal length), but it is also contemplated that the triangular shape of each of the rings could be in the form of an equilateral triangle (with all three sides being of equal length), or in the form of a scalene triangle (with none of the three sides being of equal length). FIG. 8B shows a tacking fastener element 10 with a plurality of annular rings 232 that are each of a sawtooth shape (i.e., of a right-triangular shape), when viewed in cross-section, where each of the rings 232 includes a crest 232A as its radially outermost point.

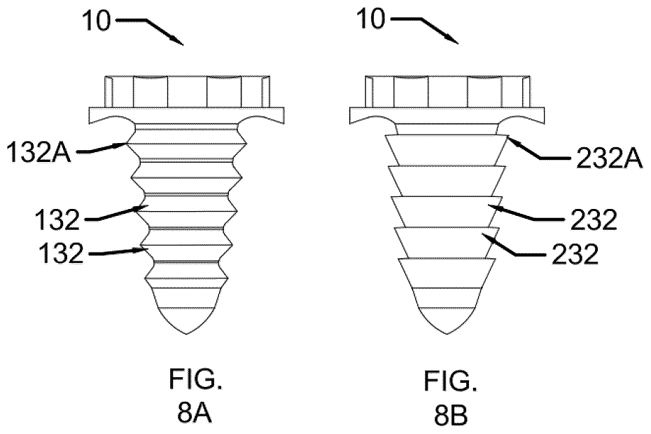

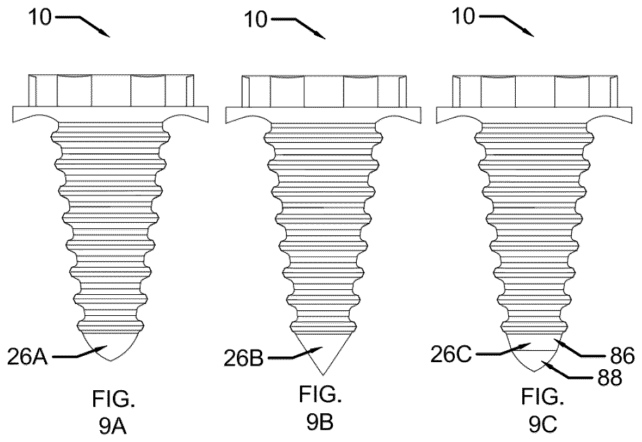

Turning now to FIGS. 9A-9C, various styles of the tip portion will be discussed. FIG. 9A shows a tip portion 26A that is of a radiused concave shape, and FIG. 9B shows a tip portion 26B that is of a linear conical shape. Finally, FIG. 9C shows a tip portion 26C that is a combination of the radiused concave shape of FIG. FIG. 9A and the linear conical shape of FIG. 9B, where portion 86 is the linear portion and portion 88 is the radiused portion. Of course, the tip styles discussed here are only examples, and other tip styles may also be used with the present invention.

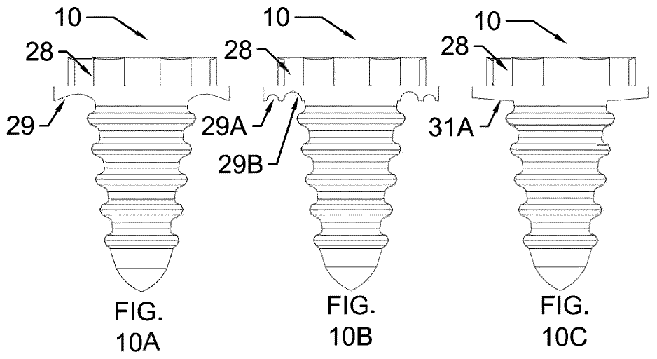

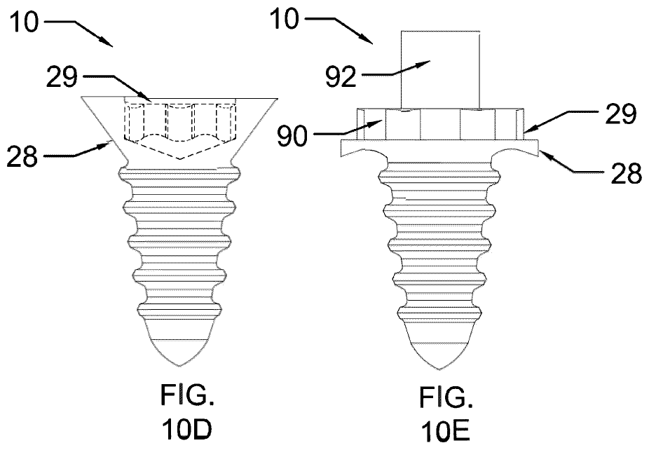

Turning now to FIGS. 10A-10E, various head styles that may be used with the current tacking fastener element are shown and will be briefly discussed. FIG. 10A shows an example of a tacking fastener element 10 of the present invention that includes the single annular undercut region 29, as discussed above with regard to some of the other figures, such as FIG. 1. FIG. 10B shows an example of a tacking fastener element 10 of the present invention that includes the two annular undercut regions 29A and 29B. Preferably, undercut region 29A is deeper and wider than undercut region 29B (i.e., under region 29A has a greater volume than undercut region 29B). Although not shown, it is contemplated that three or more undercut regions may also be provided, and preferably, each of the undercut regions is of a lesser volume going radially outwardly. Next, FIG. 10C shows an example of a tacking fastener element 10 of the present invention in which the underside surface 31A of the head portion 28 lacks any undercuts, and instead defines a tapered bearing surface. Although not shown, the underside surface 31A of a head portion that lacks any undercuts may also be formed as a flat bearing that forms a right angle with the central axis of the elongated shaft that forms the fastener element.

Turning now to FIGS. 10D and 10E, various drive regions of the head portion will be discussed. The drive region 29 is configured and arranged for receiving a rotary driving force to drive the tacking fastener element 10 into a single workpiece, or into a plurality of superposed workpieces. It is contemplated that the drive arrangement may be any type of conventionally known drive arrangement (either an internal drive arrangement, such as slotted, Phillips, Torx, square, hex, socket, etc. or an external drive arrangement, such as hex, 12-point, line head, Torx, Torx Plus, etc.). For example, FIG. 10D shows a drive region 29 that includes a countersunk shape that is configured as an internal Torx drive system. FIG. 10E shows a drive system 29 that includes an external drive portion 90 configured as a 12-point external drive. In addition, the head portion 28 of the tacking fastener element 10 of FIG. 10E also includes a secondary shaft 92 that is configured and arranged for receiving an additional component after the tacking fastener element 10 has been installed into a workpiece. In order to receive such an additional component, the secondary shaft is threaded, tapered or otherwise modified to receive a complementary portion of the additional component.

While various embodiments of the present invention have been shown and described, it should be understood that other modifications, substitutions and alternatives may be apparent to one of ordinary skill in the art. Such modifications, substitutions and alternatives can be made without departing from the spirit and scope of the invention, which should be determined from the appended claims.

Various features of the invention are set forth in the appended claims.

1. A tacking fastener element comprising:
an elongated shaft extending in an axial direction between a first shaft end and a second shaft end;
a tip portion provided at the first shaft end, wherein the tip portion is configured and arranged to create sufficient heat, via friction during rotary installation into a workpiece, to soften material of the workpiece adjacent the tip portion, thereby creating a flowed/extruded portion of the workpiece;
a head portion arranged at the second shaft end, wherein the head portion includes a drive region configured and arranged to receive a rotary driving force; and
an annular ring portion provided between the tip portion and the head portion, wherein the annular ring portion includes a plurality of annular rings that are each non-helical and each include a crest, and further wherein a root is defined between each pair of adjacent crests, and
wherein a primary taper angle is defined between a pair of crest lines on radially opposite sides of each other, wherein each of the crest lines is a line formed by connecting a radially outermost point of each of a plurality of said crests, and
further wherein the primary taper angle is between approximately 10 degrees and approximately 20 degrees.

2. A tacking fastener element comprising:
an elongated shaft extending in an axial direction between a first shaft end and a second shaft end;
a tip portion provided at the first shaft end, wherein the tip portion is configured and arranged to create sufficient heat, via friction during installation into a workpiece, to soften material of the workpiece adjacent the tip portion, thereby creating a flowed/extruded portion of the workpiece;
a head portion arranged at the second shaft end, wherein the head portion includes a drive region configured and arranged to receive a rotary driving force; and
an annular ring portion provided between the tip portion and the head portion, wherein the annular ring portion includes a plurality of annular rings that are each non-helical and each include a crest, and further wherein a root is defined between each pair of adjacent crests; and
wherein a primary taper angle is defined between a pair of crest lines on radially opposite sides of each other, wherein each of the crest lines is a line formed by connecting a radially outermost point of each of a plurality of said crests, and
wherein the primary taper angle is between approximately 10 degrees and approximately 20 degrees;
wherein said crests comprise a plurality of first crests provided within a first region of the annular ring portion and a plurality of second crests provided within a second region of the annular ring portion, wherein the second region of the annular ring portion is closer to the head portion than the first region of the annular ring portion;
wherein the pair of crest lines of the primary taper angle are associated with the plurality of first crests; and
wherein a secondary taper angle is defined between a pair of second crest lines on radially opposite sides of each other, wherein each of the second crest lines is a line formed by connecting a radially outermost point of each of a plurality of said second crests.

3. The tacking fastener element according to claim 2, wherein the secondary taper angle is greater than the primary taper angle by approximately 15 degrees or less.

4. The tacking fastener element according to claim 2, wherein the secondary taper angle is less than the primary taper angle by approximately 15 degrees or less.

5. The tacking fastener element according to claim 1, wherein at least some of the annular rings are arranged perpendicular to a central axis of the elongated shaft.

6. The tacking fastener element according to claim 1, wherein all of the annular rings are arranged perpendicular to a central axis of the elongated shaft.

7. A tacking fastener element comprising:
an elongated shaft extending in an axial direction between a first shaft end and a second shaft end;
a tip portion provided at the first shaft end, wherein the tip portion is configured and arranged to create sufficient heat, via friction during installation into a workpiece, to soften material of the workpiece adjacent the tip portion, thereby creating a flowed/extruded portion of the workpiece;
a head portion arranged at the second shaft end, wherein the head portion includes a drive region configured and arranged to receive a rotary driving force; and
an annular ring portion provided between the tip portion and the head portion, wherein the annular ring portion includes a plurality of annular rings that are each non-helical and each include a crest, and further wherein a root is defined between each pair of adjacent crests, and
wherein a primary taper angle is defined between a pair of crest lines on radially opposite sides of each other, wherein each of the crest lines is a line formed by connecting a radially outermost point of each of a plurality of said crests,
further wherein the primary taper angle is between approximately 10 degrees and approximately 20 degrees, and
still further wherein the head portion includes an annular undercut region in an underside thereof, where the annular undercut region is configured and arranged for receiving material of the flowed/extruded portion of the workpiece created during installation of the tacking fastener element into the workpiece.

8. The tacking fastener element according to claim 1, wherein an axial length of the tip portion, as defined between a distal end surface of the tip portion and an adjacent one of the annular rings, is less than or equal to 0.8 times an outer diameter of the annular ring of largest diameter.

9. The tacking fastener element according to claim 8, wherein the axial length of the tip portion is also greater than or equal to 0.2 times the outer diameter of the annular ring of largest diameter.

10. The tacking fastener element according to claim 2, wherein an under-head length, defined as an axial length between an underside surface of the head portion and a distal end surface of the tip portion, is greater than 1.5 times an outer diameter of the annular ring of largest diameter.

11. The tacking fastener element according to claim 1, wherein an annular ring height, defined as a radial distance between a crest of an annular ring and an adjacent root, is the same for each of the plurality of annular rings of the annular ring portion.

12. The tacking fastener element according to claim 1, wherein an annular ring height, defined as a radial distance between a crest of an annular ring and an adjacent root, differs between at least some of the plurality of annular rings of the annular ring portion.

13. The tacking fastener element according to claim 1, wherein an annular ring height, defined as a radial distance between a crest of an annular ring and an adjacent root, gradually increases between the annular ring closest to the tip portion and the annular ring closest to the head portion.

14. The tacking fastener element according to claim 1, wherein each of the annular rings is in the form of a triangle, when viewed in cross-section.

15. The tacking fastener element according to claim 1, wherein each of the annular rings is in the form of sawtooth, when viewed in cross-section.

16. The tacking fastener element according to claim 1, wherein each of the annular rings includes an optimized smooth tapering sawtooth geometry which satisfies the following:
(a) an advancing radius is 0.3-0.7 times the outer diameter of the annular ring of the largest diameter;
(b) a root width is 0.13-0.25 times the outer diameter of the annular ring of the largest diameter;
(c) a peak radius is 0.1-0.22 times the outer diameter of the annular ring of the largest diameter;
(d) a retreating radius is 0.015-0.04 times the outer diameter of the annular ring of the largest diameter;
(e) a retreating edge has an angle of 70-110 degrees relative to the central axis of the elongated shaft; and
(f) an annular ring height is 0.075-0.15 times the outer diameter of the annular ring of the largest diameter.

17. The tacking fastener element according to claim 1, wherein each of the annular rings includes an optimized bilinear geometry which satisfies the following:
(a) a top angle φ is between 110 and 135 degrees;
(b) a root angle α is between 35 and 60 degrees;
(c) a top width is between 0.02 and 0.07 times the outer diameter of the annular ring of the largest diameter;
(d) a root width is between 0.07 and 0.11 times the outer diameter of the annular ring of the largest diameter;
(e) a root radius is approximately 0.02 times the outer diameter of the annular ring of the largest diameter; and
(f) the annular ring height is between 0.04 and 0.08 times the outer diameter of the annular ring of the largest diameter.

18. An installation method for installing a tacking fastener element into a workpiece, using the tacking fastener element according to claim 1, wherein the method comprises:
rotating the tacking fastener element via the driver region at a speed ranging from between 2,000 RPM and 20,000 RPM while simultaneously applying a maximum of 5 kN end load axially to the tacking fastener element, thereby generating frictional heat at the first shaft end of the tacking fastener element resulting in material displacement upwards towards the head portion as the tip portion penetrates into the workpiece; and
performing continued rotation such that the annular rings contact the workpiece, each subsequent ring displaces material of the workpiece using frictional softening from heat to fill a recess behind a preceding ring, thereby creating a wavelike effect of material deformation and flow as the tacking fastener element penetrates deeper into the workpiece.

19. The installation method according to claim 18, wherein the head portion includes an annular undercut region in an underside thereof, where the annular undercut region is configured and arranged for receiving material of the flowed/extruded portion of the workpiece created during installation of the tacking fastener element into the workpiece, wherein the method further comprises:
the annular undercut region compressing the material displaced upwards toward the head region behind a final one of the annular rings such that each space between adjacent annular rings is occupied with material of the workpiece; and
terminating rotation of the tacking fastener element when the tacking fastener element has been driven to a target depth such that the underside of the head portion contacts a top surface of the workpiece.

20. The installation method according to claim 19, wherein the step of terminating rotation of the tacking fastener element results in the underside of the head portion compressing into the top surface of the workpiece.
